(19) United States
(12) Patent Application Publication
(10) Pub. No.: US 2005/0232750 A1
(43) Pub. Date: Oct. 20, 2005

(54) Method for loading of container used to ship semi-trailer chassis

(76) Inventors: Sidong He, Shenzhen (CN); Shulin Yang, Shenzhen (CN); Feng Wang, Shenzhen (CN); Xuezhong Ye, Shenzhen (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 11/095,606

(22) Filed: Apr. 1, 2005

(30) Foreign Application Priority Data
Feb. 5, 2005 (CN) 200510052317.0
Apr. 6, 2004 (CN) 200420049821.6

(51) Int. Cl. B65F 9/00

(52) U.S. Cl. 414/809

(57) ABSTRACT

A method used for loading of container shipping semi-trailer chassis, in which container mentioned includes base frame and four frame structures fixed on angle post of base frame; four semi-trailer chassis are loaded into the container in the order from bottom to top according to positioning of the first semi-trailer chassis being placed upside down, the second one being placed upside up and turned by 180 degree horizontally, the third one being placed upside down, the forth one being placed upside up and turned by 180 degree horizontally. Loading space of container can be effectively used to load 4 units of semi-trailer chassis with length of 40 feet, 20 feet or telescopic 45 feet, 53 feet and other size, loading efficiency has been enhanced, shipping cost has been tremendously lowered comparing with bulk cargo ship, and it satisfies the requirements of containerization multiple mode through-shipping, scheduled international multiple mode through-shipping can be realized by using container liner, satisfying shipping requirements of semi-trailer chassis.

### FIELD OF THE INVENTION

The invention is on the subject of a transportation method of semi-trailer chassis, it especially deals with loading method of multiple semi-trailer chassis in the container which is used for transportation of semi-trailer.

### BACKGROUND OF THE INVENTION

Semi-trailer is a widely-used container transportation tool, of which the key part is its chassis, upon usage, semi-trailer chassis can be hauled by traction vehicle, container can be fixed on semi-trailer chassis to realize transportation function.

At present, production of semi-trailer chassis have been transferred to developing countries to reduce production cost, but main consuming market and usage area are still in developed countries. In transportation of semi-trailer chassis from place of production to marketplace and place of usage, it is normally necessary to go through multiple modes through transportation via highway, railway and ocean, transportation cost is a key factor affecting its product cost composition, usually high transportation cost will cause high cost of product and loss of market competitive capacity.

Initially semi-trailer chassis are transported on sea by bulk cargo ship, where five units of semi-trailer chassis are tied and piled up together for transportation, transportation coat is high, and trough transportation operation is complicated, and there is shortage of bulk cargo ship line, it is impossible to realize scheduled transportation like container line, and it is difficult to satisfy transportation demand of semi-trailer chassis, this affects production of semi-trailer chassis directly, therefore, it is necessary to adopt an efficient and low-cost transportation method. So it is proposed to transport semi-trailer chassis in container. Container is a standard international general-purpose transportation tool used in multiple modes through transportation, container can be piled up to enhance storage capacity of deck of a ship, so that transportation cost can be reduced, transportation efficiency can be enhanced, therefore frame type contain transporting semi-trailer chassis are researched, developed and designed.

In usage of container to ship semi-trailer chassis, only providing the size after loading meet length, width and height required by standard container transportation, it is possible to realize multiple modes thorough transportation and containerize transportation of semi-trailer chassis and reduce transportation cost of semi-trailer chassis. But due to special characteristics of structure of semi-trailer chassis, its loading method will directly determine whether it is possible to transport semi-trailer chassis and size of container after loading of semi-trailer chassis, and the loading method determines the maximum quantity of semi-trailer chassis to be transported by container.

### SUMMARY OF THE INVENTION

The purpose of this invention is to provide a loading method of container with adoption of containerized transportation of semi-trailer chassis, size of container after loading of, semi-trailer chassis should meet requirements of container multiple modes thorough transportation, so that transportation of semi-trailer chassis can be containerized, and quantity of semi-trailer chassis to be loaded into container can be maximized to reduce shipping cost.

To realize the above mentioned purpose, the technical solution of the invention is indicated as follows:

A method used for loading of container shipping semi-trailer chassis, in which container mentioned includes base frame and four frame structures fixed on angle post of base frame; four semi-trailer chassis are loaded into the container in the order from bottom to top according to positioning of the first semi-trailer chassis being placed upside down, the second one being placed upside up and turned by 180 degree horizontally, the third one being placed upside down, the forth one being placed upside up and turned by 180 degree horizontally.

In preferential solution of this invention, the described method used for loading of container shipping semi-trailer chassis indicates that end of wheel of the first semi-trailer chassis is close to angle post of the container and is supported by carrying face of side beam of container, lock of wheel end of the semi-trailer is locked in lock hole of side beam on bottom of container.

The described method used for loading of container shipping semi-trailer chassis indicates that the second unit of semi-trailer chassis is placed on the first unit of semi-trailer chassis and the second semi-trailer chassis is connected with the first unit of semi-trailer chassis at wheel and goose neck beam, back end of the second semi-trailer chassis is adjacent with angle post of the container; repeat loading method of the first and second unit of semi-trailer chassis for loading of the third and fourth unit of second semi-trailer chassis.

The described method used for loading of container shipping semi-trailer chassis indicates that, from bottom to top, axis of wheel suspension frame and reinforcing plate of leg of the first unit of semi-trailer chassis will be connected with axis of wheel suspension frame and reinforcing plate of leg of the second unit of semi-trailer chassis respectively, repeat loading method of the first and second unit of semi-trailer chassis for loading of the third and fourth unit of second semi-trailer chassis.

The described method used for loading of container shipping semi-trailer chassis indicates that the second unit of semi-trailer chassis and the first unit of semi-trailer chassis are positioned reversely from tail to head in the other side of base frame of container, back end of the second semi-trailer chassis is adjacent with angle post of the other end of container, its wheel is supported by carrying face of bottom and side beam of container, its front end is located above front side of the first unit of semi-trailer chassis, adjust leg of the second semi-trailer chassis so that it is supported by base frame of the container; repeat loading method of the first and second unit of semi-trailer chassis for loading of the third and fourth unit of second semi-trailer chassis.

The described method used for loading of container shipping semi-trailer chassis indicates that the first to the fourth semi-trailer chassis are fastened to container mentioned further.

With adoption of above mentioned technical solution, loading space of container can be effectively used to load 4 units of semi-trailer chassis with length of 40 feet, 20 feet or telescopic 45 feet, 53 feet and other size, loading efficiency has been enhanced, shipping cost has been tremendously lowered comparing with bulk cargo ship, and it satisfies the requirements of containerization multiple modes through-shipping, scheduled international multiple modes through-shipping can be realized by using container liner, satisfying shipping requirements of semi-trailer chassis.

### BRIEF DESCRIPTION OF THE DRAWINGS

Combined with drawings attached as follows, through detailed description of specific implementation approach of this invention, it will be clear and easy to see technical solution and other beneficial effects of this invention.

FIG. 1 is the front view of container described in this invention for transportation of semi-trailer chassis;

FIG. 2 is top view of FIG. 1;

FIG. 3 is A direction view of FIG. 1;

FIG. 4 is enlarged section drawing of E-E direction of FIG. 3, which illustrates the first type of implementation example of section of reinforced structure of angle column; F

FIG. 5 is enlarged section drawing of E-E direction of FIG. 3, which illustrates the second type of implementation example of section of reinforced structure of angle column;

FIG. 6 is enlarged section drawing of E-E direction of FIG. 3, which illustrates the third type of implementation example of section of reinforced structure of angle column;

FIG. 7 is B-direction view of FIG. 1:

FIG. 8 is enlarged view of C section of FIG. 2:

FIG. 9 is top view of the second implementation method of bottom side beam of base frame;

FIG. 10 is enlarged section drawing of D-D direction of FIG. 2, which illustrates the first type of implementation example of cross section of bottom side beam of base frame;

FIG. 11 is enlarged section drawing of D-D direction of FIG. 2, which illustrates the second type of implementation example of cross section of bottom side beam of base frame;

FIG. 12 is enlarged section drawing of D-D direction of FIG. 2, which illustrates the third type of implementation example of cross section of bottom side beam of base frame;

FIG. 13 is abridged general view of loading of the first unit of 40 feet semi-trailer chassis in container described in this invention;

FIG. 14 is abridged general view of loading of the second unit of 40 feet semi-trailer chassis in container described in this invention;

FIG. 15 is abridged general view of loading of the third unit of 40 feet semi-trailer chassis in container described in this invention;

FIG. 16 is abridged general view of loading of the forth unit of 40 feet semi-trailer chassis in container described in this invention;

FIG. 17 is graphic model of 40 feet semi-trailer chassis;

FIG. 18 is enlarged drawing of section I of FIG. 17;

FIG. 19 is enlarged drawing of section II of FIG. 17;

FIG. 20 is abridged general view of loading of the first unit of 20 feet semi-trailer chassis in container described in this invention;

FIG. 21 is abridged general view of loading of the second unit of 20 feet semi-trailer chassis in container described in this invention;

FIG. 22 is abridged general view of loading of the third unit of 20 feet semi-trailer chassis;

FIG. 23 is abridged general view of loading of the forth unit of 20 feet semi-trailer chassis.

### DESCRIPTION OF THE PREFERRED EMBODIMENTS

To further understand characteristics and technical content of the invention, please see the following relevant detailed illustration and drawing attached regarding this invention, but the attached drawing is provided only for reference and illustration, they are not supposed to restrict this invention.

To make full use of space of frame type of container for effective loading of semi-trailer chassis with length of 40 feet, 20 feet or telescopic 45 feet, 53 feet and other specification, a new type of method to load semi-trailer chassis in container is adopted in the invention.

As showed in FIG. 1 and FIG. 2, container used for transportation of semi-trailer chassis is open frame structure, including base frame 4 and four pieces of angle post 2; apex angle part 1 is fixed on top of angle post 2, base angle part 3 is fixed on bottom and fixed on base frame 4; base frame 4 consists of two bottom side beam 6, between which there are numerous bottom cross beam 7, doorsill 5 and base angle part 3 distributed in parallel and fixed on them.

There are numerous alternatives for fixing of bottom side beam 6, doorsill 5 and angle post 2, for example: the first alternative is that two ends of side beam 6 are fixed respectively between base angle part 3 on the two angle post 2 on the same side of base frame 4 and installed on the two base angle part 3, doorsill 5 is installed between base angle part 3 on two angle post 2 on the same side of base frame 4 and installed on base angle part 3; the second alternative is two ends of side beam 6 are fixed respectively between base angle part 3 on the two angle post 2 on the same side of base frame 4 and installed on the two base angle part 3, doorsill 5 is installed directly between two bottom side beam 6, so that space between the two pieces of bottom side beam 6 can be reduced, therefore reduce length of bottom cross beam 7 and save material; the third alternative is that bottom side beam 6 and doorsill 5 can be fixed on angle post 2. Of course there are other options for assembling structure of container, the first assembling structure is showed in drawing.

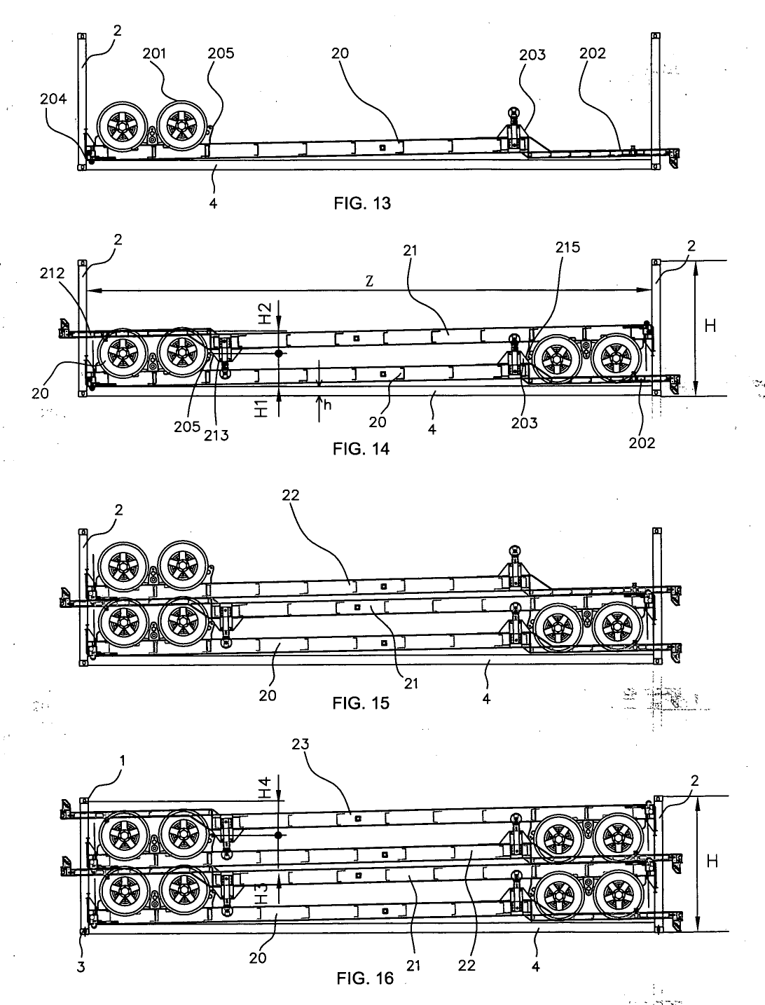

The first implementation method of loading approach of this invention is illustrated in FIG. 13 to FIG. 16. There are 4 units of semi-trailer chassis loaded in container.

In order to satisfy requirements of loading and multiple modes thorough transportation at the same time, external width size, height size and angle part positioning size of ISO 1 AAA type container is adopted, external length size meets or exceeds specification of ISO 1 AAA container.

To realize the purpose to load 4 units of semi-trailer chassis in container, upon loading, every two units of semi-trailer chassis must be arranged reversely in terms of head-tail and upside-downside, so that wheel and goose neck beam can be connected together to form a unit, then pile, up the two units and load inside container. The specific loading method is as follows:
First, put the first semi-trailer chassis 20 with upside down on bottom frame 4 of container, back end of semi-trailer chassis 20 is close to angle post 2 on one side of container and supported by carrying face of bottom side beam of container, in case there is lock hole 10 on bottom side beam, referring FIG. 2 and FIG. 8 to lock in the lock 204 at the back end of chassis 20 and lock hole 10.
Then, place the second unit of semi-trailer chassis 21 on the first unit of semi-trailer chassis 20 so that the second unit of semi-trailer chassis 21 is connected with the first unit of semi-trailer chasssis 20 at wheel 201 and goose neck beam 202, the two chassis are placed in reverse head-tail order, back end of the second unit of semi-trailer chassis 21 is adjacent with angle post 2 on the other side of the container;
Thirdly, place the third unit of semi-trailer chassis 22 upside down on the second unit of semi-trailer chassis 21 so that its head-tail direction is identical with the first unit of semi-trailer chassis 20, its back end of is adjacent with angle post 2 on one side of the container;
Fourthly, place the fourth unit of semi-trailer chassis 23 on the third unit of semi-trailer chassis 22, so that the fourth unit of semi-trailer chassis 23 and the third unit of semi-trailer chassis 22 are connect on the position of wheel and goose neck beam, head-tail direction of the fourth unit of semi-trailer chassis 23 is identical with the second unit of semi-trailer chassis 21, its back end of is adjacent with angle post 2 on one side of the container;
Finally, fasten the first to the fourth unit of semi-trailer chassis on container.

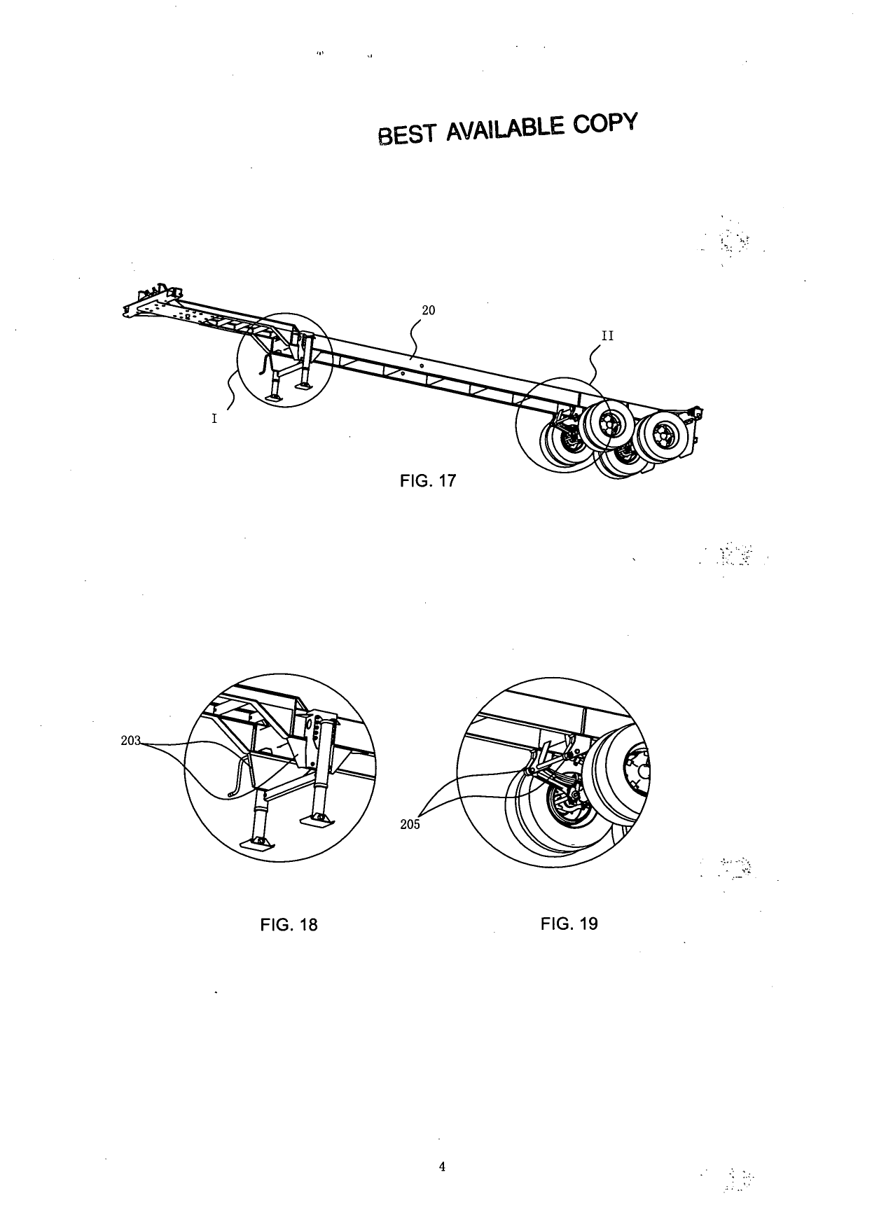

During loading, axis of wheel suspension frame 205 and reinforcing plate 203 of leg of the first unit of semi-trailer chassis 20 will be connected with axis of wheel suspension frame 215 and reinforcing plate 213 of leg of the second unit of semi-trailer chassis 21 respectively, please refer to FIG. 17 and FIG. 19 for structure of suspension frame and reinforcing plate of leg; repeat loading method of the first and second unit of semi-trailer chassis for loading of the third and fourth unit of second semi-trailer chassis.

In FIG. 13 to FIG. 16, size parameters illustrated are as follows:
Z: Inside width of container, i.e. distance between internal side face of the left and rig, angle post.
H1: Vertical distance between carrying face of the first unit of semi-trailer chassis and point of tangent of axis of wheel suspension frame of the first semi-trailer chassis and reinforce plate of leg of the second unit of semi-trailer chassis, axis of wheel suspension frame is of a circular face, and reinforce plate of leg is of bevel, therefore position of the point of tangent of the two is fixed, i.e. H1 is a constant determined by structure parameter of semi-trailer chassis itself;
H2: Vertical distance between the point of tangent mentioned in H1 and orthogonal projection of goose neck beam 212 of the second unit of semi-trailer chassis on left angle post 2 of container, position of the above mentioned point of tangent on reinforce plate of leg will change according to horizontal relative stacking position of the two units of semi-trailer chassis, i.e. it will change with change of Z;
H3: Vertical distance between carrying face of the third unit of semi-trailer chassis and the point of tangent of axis of wheel suspension frame of the third semi-trailer chassis and reinforce plate of leg of the fourth unit of semi-trailer chassis, it is identical or related to H1;
H4: Vertical distance between the point of tangent mentioned in H3 and top of handle plate of the fourth unit of semi-trailer chassis, it is related with H2;
h: Height of bottom side beam;
H: Standard external height of container;

To meet transportation standard of container, stacking of four units of semi-trailer chassis should not exceed top surface of top angle part 1, i.e., H must be totals of h, H1, H2, H3 and H4.

Z Determines relative position of stacking of each group of semi-trailer chassis (the first unit, the second unit, the third unit and the fourth unit), i.e. H2 is determined by the height of tangent of axis of wheel suspension frame of the first semi-trailer chassis and reinforce plate of leg of the second unit of semi-trailer chassis on reinforce plate of leg of the second unit of semi-trailer chassis. That is to say H2 is a dependent variable of Z. The same with H4.
H2=F₁(Z)
H4=F₂(Z)

H is specified by national standard, h equals H minus H1, H2, H3 and H4, therefore h is also a dependent variable of Z.
h=F₃(Z)

To load semi-trailer chassis with length of 40 feet and telescopic 45 feet and 53 feet, there are at least two requirements regarding structure parameter of container: firstly back end cross beam of the first unit of semi-trailer chassis 20 which is supposed to be loaded upside down in bottom unit should be adjacent to angle post 2 on one end of container and rested on bottom beam 6, back end of the second semi-trailer chassis 21 which is loaded upside up in reverse direction should be adjacent with angle post 2 on the other end, its wheel 201 is on bottom side beam 6, to ensure that loading height of the four units of semi-trailer chassis will not exceed surface height of top angle part 1, the distance between the lowest point of carrying face of bottom side beam 6 and bottom face of bottom angle part should be less than or equal 365 mm; secondly regarding the section of internal surface of angle post 2 facing back end beam of semi-trailer chassis loaded, horizontal distance on the longwise direction of the container should be more than or equal 11836 mm, in case the horizontal distance is taken as 11846, it can meet requirements of loading ideally.

As illustrated in FIG. 3, to realize the design target of horizontal distance of angle post 2 above mentioned being larger or equal 11836 mm, ensure that angle post 2 meets strength requirements of ISO test, on the internal side of two angle post 2 which are on the same side of base frame 4, it is necessary to configure angle post reinforcing structure 8 which extends from upper part of angle post 2 to bottom part and is fastened on angle post 2 and doorsill 5 to strengthen cross rigidness of angle post 2, meanwhile it is also necessary to configure reinforcing structure 11 between angle post 2 and bottom side beam 6, it is illustrated in FIG. 1, the reinforcing structure, 11 can adopt reinforcement bar plate and reinforcement cross stay and other normal strengthening structures to enhance lengthwise rigidness of angle post 2. For the convenience of loading of semi-trailer chassis, there is guiding slope on top section of reinforcing structure of angle post 8.

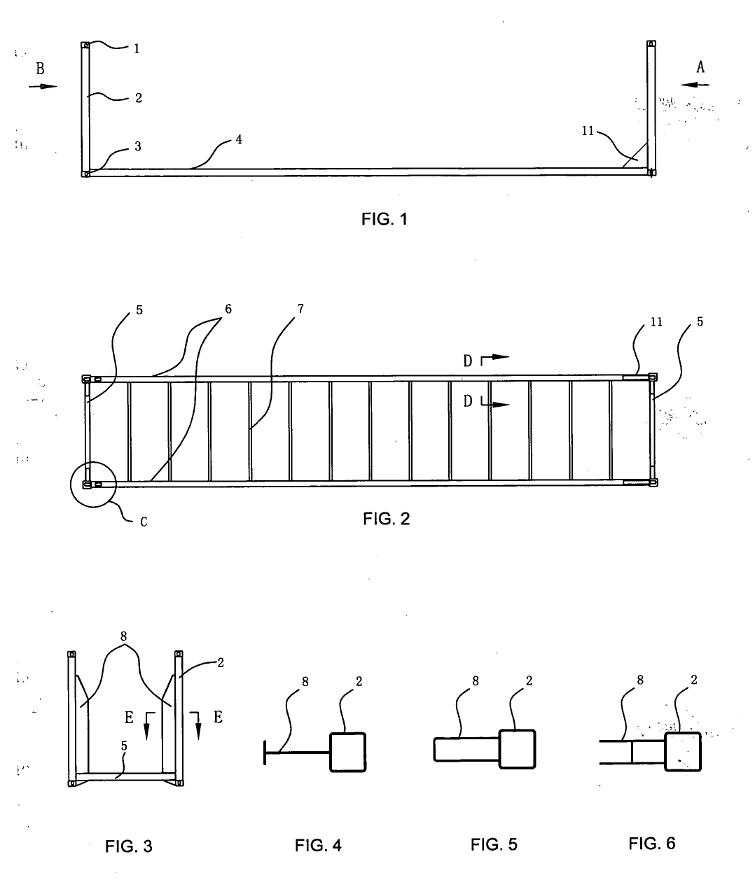

The three kinds of implementation method of cross section of reinforcing structure 8 of angle post are illustrated in FIG. 4, FIG. 5 and FIG. 6: T shape cross section, channel cross section and I-shaped cross section.

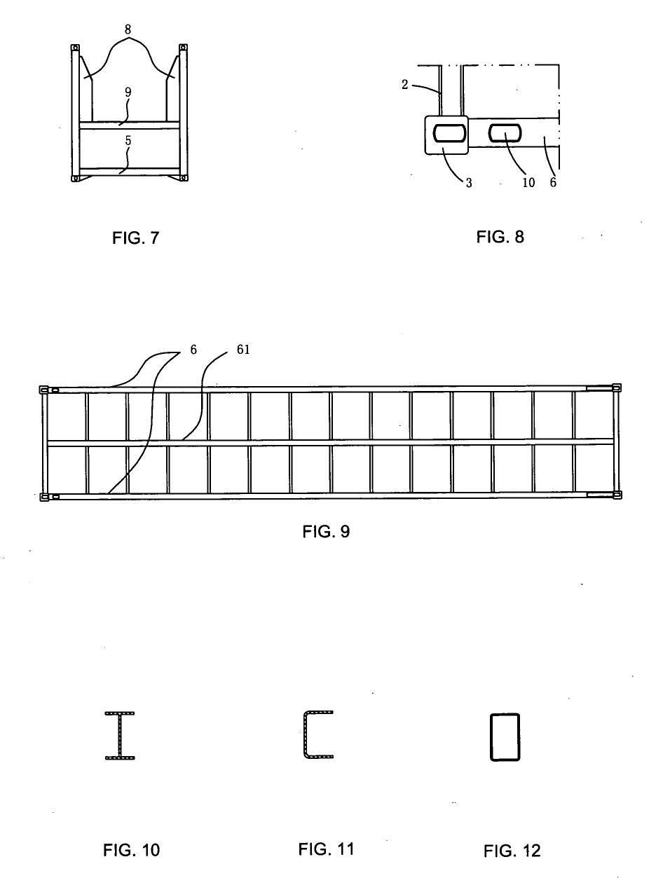

As illustrated in FIG. 7, at appropriate position of lower-middle part of angle post 2 on one side of container, configure a horizontal cross beam 9 which is fastened with two angle post 2, reinforcing structure 8 of angle post extends from upper part of angle post 2 down to horizontal cross beam 9, and is fastened with angle post 2 and horizontal cross beam 9. Height of horizontal cross beam 9 should be suitable so that, after loading of the second unit of semi-trailer chassis, undersurface of front end goose neck beam 212 of semi-trailer chassis 21 can be supported by horizontal cross beam 9, and ensure horizontal status of semi-trailer chassis 21. After the two angle post 2 are fastened together by horizontal cross beam 9, in case angle 2 can get enough lengthwise rigidness meeting strength requirements of ISO test after calculation of strength and sample box test, then reinforcing bar 11 between angle post 2 and bottom side beam 6 can be dispensed with.

In case structure without horizontal cross beam 9 is adopted for angle post structure on two sides of container body, container body meet requirements of loading of 20 feet semi-trailer chassis, in case structure with horizontal cross beam 9 is adopted for one side of angle post of container body, the other side do not adopt horizontal cross beam 9, container body meet requirements loading of 20 feet, 40 feet and telescopic 45 feet and 53 feet semi-trailer chassis.

For better convenience of loading of semi-trailer chassis, as illustrated in FIG. 8, at appropriate position being adjacent to bottom angle part on both sides of bottom side beam 6, configure lock hole 10 corresponding to back end lock of semi-trailer chassis, in case the first unit of semi-trailer chassis 20 is loaded on base frame 4 with upside down, its back end lock can lockup the semi-trailer chassis 20 in lock hole 10. Position of lock hole 10 should enable that back end of semi-trailer chassis 20 is adjacent to neighboring angle post 2 after lockup of semi-trailer chassis 20.

To ensure meeting of ISO strength requirements regarding container body, meanwhile ensure that carrying face of bottom side beam get required height, base frame structure with bottom side beam quantity being equal or more than 3 pieces can be adopted. In FIG. 9, base frame structure with 3 pieces of bottom side beam is illustrated, the middle bottom side beam 61 acts to take bending moment load of bottom side beam 6, so that bottom side beam 6 and middle bottom side beam 61 can get height meeting requirements.

To ensure meeting of ISO strength requirements regarding container body, meanwhile ensure that carrying face of bottom side beam get required height, reasonable section of bottom side beam can be adopted to meet requirements. FIGS. 10, 11 and 12 show the implementation method of 3 kinds of cross section of bottom side beam 6 respectively: I-shaped section, channel cross section and rectangle section, to make full use of resistance to bending of bottom side beam 6 and save material, it is workable to adopt the above mentioned section shape or its combination on same piece of bottom side beam by section, of course, it is workable to adopt configuration of reinforcing plate on top side face on middle section of bottom side beam or other normal structure solution to strengthen bottom side beam.

The so called “fastening” above mentioned refers to connection methods meeting requirements of structure strength described, including weld connection, bolt connection, rivet connection, brute force adherence and etc

Loading method of telescopic 45 feet and 53 feet semi-trailer chassis is that first extract the length of semi-trailer chassis to 40 feet, then proceed according to loading steps of 40 feet semi-trailer chassis.

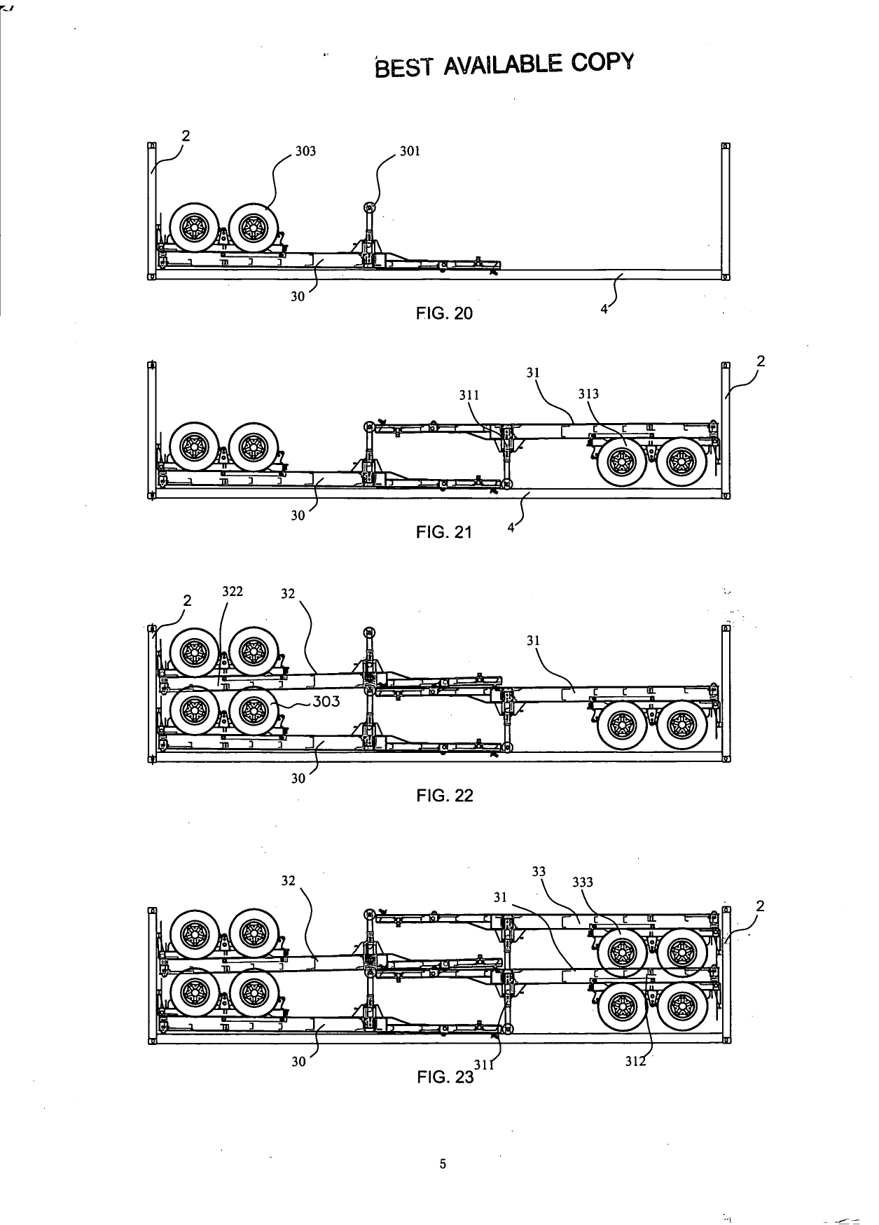

FIG. 20 to FIG. 23 show the second implementation example of loading method of this invention, illustrating the method to load 20 feet semi-trailer chassis into container:
First, put the first semi-trailer chassis 30 with upside down on bottom frame 4 of container, back end of semi-trailer chassis 30 is close to angle post 2 on one side of container and supported by carrying face of bottom side beam of container, in case there is lock hole on bottom side beam, lockup the lock at the back end of semi-trailer chassis 20 into lock hole;
Then, place the second unit of semi-trailer chassis 31 and the first unit of semi-trailer chassis 30 on the other end of base frame 4 of container with reverse head-tail direction, back end of the second unit of semi-trailer chassis 31 is adjacent with angle post 2 on the other side of the container, its wheel 313 is supported by carrying face of bottom side beam of container, its front side is above the front end of the first unit of semi-trailer chassis 30, adjust leg 311 of the second unit of semi-trailer chassis 31 and support it with base frame 4;
Thirdly, place the third unit of semi-trailer chassis 32 upside down on the first unit 6 semi-trailer chassis 30, so that its head-tail direction is identical with the first unit of semi-trailer chassis 30, its back end is adjacent with angle post 2 on one side of the container, wheel 303 of the first unit of semi-trailer chassis 30 and girder 322 of the third unit of semi-trailer chassis are connected together; front end support of the third unit of semi-trailer chassis 32 rests on leg 301 of the first unit of semi-trailer chassis 30;
Fourthly, place the fourth unit of semi-trailer chassis 33 on the second unit of semi-trailer chassis 31 with a direction identical to the second unit of semi-trailer chassis 31, so that wheel 333 of the fourth unit of semi-trailer chassis 33 and girder 312 of the second unit of semi-trailer chassis 31 are connected, back end of the fourth unit of semi-trailer chassis 33 is adjacent with angle post 2 on one side of the container, its front end support is above the leg 311 of the second unit of semi-trailer chassis 31;
Finally, fasten the first to the fourth unit of semi-trailer chassis on container.

According to common sense of technology, the invention can be realized through other implement solutions without deviation with its essence or necessary characteristics. Therefore, the above mentioned implementation solutions published are only illustration by examples in terms of all respects, they are not the only one. All changes within the range of this invention or within the range equals to this invention will be covered by this invention.

1. A method used for loading of container which ships semi-trailer chassis, in which container mentioned includes base frame and four frame structures fixed on angle post of base frame, featuring that four semi-trailer chassis are loaded into the container in the order from bottom to top according to positioning of the first semi-trailer chassis being placed upside down, the second one being placed upside up and turned by 180 degree horizontally, the third one being placed upside down, the forth one being placed upside up and turned by 180 degree horizontally.

2. The method as claimed in claim 1, the characteristics lie in that end of wheel of the first semi-trailer chassis is close to angle post of the container and supported by carrying face of side beam, lock of wheel end of the semi-trailer is locked in lock hole of side beam on bottom of container.

3. The method as claimed in claim 2, the characteristics lie in that the second unit of semi-trailer chassis is placed on the first unit of semi-trailer chassis and the second semi-trailer chassis is connected with the first unit of semi-trailer chassis at wheel and goose neck beam, back end of the second semi-trailer chassis is adjacent with angle post of the container; repeat loading method of the first and second unit of semi-trailer chassis for loading of the third and fourth unit of second semi-trailer chassis.

4. The method as claimed in claim 3, the characteristics lie in that, from bottom to top, axis of wheel suspension frame and reinforcing plate of leg of the first unit of semi-trailer chassis will be connected with axis of wheel suspension frame and reinforcing plate of leg of the second unit of semi-trailer chassis, repeat loading method of the first and second unit of semi-trailer chassis for loading of the third and fourth unit of second semi-trailer chassis.

5. The method as claimed in claim 2, the characteristics lie in that the second unit of semi-trailer chassis and the first unit of semi-trailer chassis are positioned reversely from head to tail in the other side of base frame of container, back end of the second semi-trailer chassis is adjacent with angle post of the other end of container, adjust leg of the second semi-trailer chassis so that it is supported by base frame of the container; repeat loading method of the first and second unit of semi-trailer chassis for loading of the third and fourth unit of second semi-trailer chassis.

6. The method as claimed in claim 1, the characteristics lie in that the first to the fourth semi-trailer chassis are fastened to container mentioned further.
